(19) United States
(12) Patent Application Publication
(10) Pub. No.: US 2010/0229236 A1
(43) Pub. Date: Sep. 9, 2010

(54) METHOD AND SYSTEM FOR SPAM REPORTING WITH A MESSAGE PORTION

(76) Inventor: Michal Andrzej Rybak, Bridgetown (BB)

Correspondence Address: Research in Motion Corp/SLW;Attn: Glenda Wolfe, Building 6, Brazos East, Suite 100, 5000 Riverside Drive, Irving, TX, 75039, US

(21) Appl. No.: 12/701,310

(22) Filed: Feb. 5, 2010

Related U.S. Application Data
(60) Provisional application No. 61/150,788, filed on Feb. 8, 2009.

(51) Int. Cl. G06F 21/00; G06F 15/16

(52) U.S. Cl. 726/22; 709/206

(57) ABSTRACT

Methods and systems for spam reporting with a message portion are described. In one embodiment, an electronic message is received on a mobile electronic device. A spam report policy is used on the mobile electronic device to identify a portion of the electronic message to include with a spam report. The spam report is transmitted from the mobile electronic device to a server, the spam report notifying the server that the electronic message is spam and including the portion of the electronic message without including a copy of the entire electronic message.

### CROSS-REFERENCE TO RELATED APPLICATIONS

This patent application claims priority benefit from U.S. Application No. 61/150,788 filed 8 Feb. 2009 which is incorporated herein by reference.

### FIELD

This application relates to methods and systems for messaging, and more specifically to methods and systems for sending spam reports.

### BACKGROUND

Spam continues to proliferate on networks such as the Internet despite attempts to eliminate it or reduce its frequency. Spam annoys its recipients, and causes network operators to incur increased costs.

One way in which users are combating spam is by sending spam reports that indicate received e-mails are spam. The spam reports are sent to e-mail providers (e.g., internet service providers (ISPs)), operators or other entities such as, for example one or more anti-spam vendors in hope that future e-mails of a similar nature or from a same sender will be blocked. These spam reports typically include an indication that the particular e-mail is a spam report and include a copy of the entire e-mail that is believed to be spam. The recipient of the spam reports uses spam reports from users to try to minimize the number of spam messages sent in the future, and may ultimately provide results to other e-mail providers, operators or other entities so that they can block or facilitate blocking of similar messages. Given the enormous amount of spam received by users of e-mail providers on a daily basis, a significant amount of network capacity may be devoted to incoming spam reports.

### BRIEF DESCRIPTION OF THE DRAWINGS

FIG. 1 is a block diagram of a system for spam reporting, according to an example embodiment;

FIG. 2 is a block diagram of an example mobile electronic device that may be deployed within the system of FIG. 1, according to an example embodiment;

FIG. 3 is a block diagram of an example message server that may be deployed within the system of FIG. 1, according to an example embodiment;

FIG. 4 is a block diagram of an example report server that may be deployed within the system of FIG. 1, according to an example embodiment;

FIG. 5 is a block diagram of an example spam reporting subsystem that may be deployed within the mobile electronic device of FIG. 1, according to an example embodiment;

FIG. 6 is a block diagram of an example spam report processing subsystem that may be deployed within the message server or report server of FIG. 1, according to an example embodiment;

FIG. 7 is a flowchart illustrating a method for spam reporting, according to an example embodiment; and

FIGS. 8 and 9 are flowcharts illustrating methods for spam report processing, according to example embodiments.

### DETAILED DESCRIPTION

Example methods and systems for spam reporting with a message portion are described. In the following description, for purposes of explanation, numerous specific details are set forth in order to provide a thorough understanding of example embodiments. It will be evident, however, to one of ordinary skill in the art that embodiments of the invention may be practiced without these specific details.

Mobile electronic devices receive a number of electronic messages. When one or more of the electronic messages are identified as being spam, a spam report may be sent. According to the present method and systems, the spam report may exclude certain parts of the electronic message which may not be useful in blocking future spam or are so large that efficiency of reporting is adversely affected beyond an acceptable limit. The recipient of the spam report may use the report to reduce the transmissions of future electronic messages that are considered as spam.

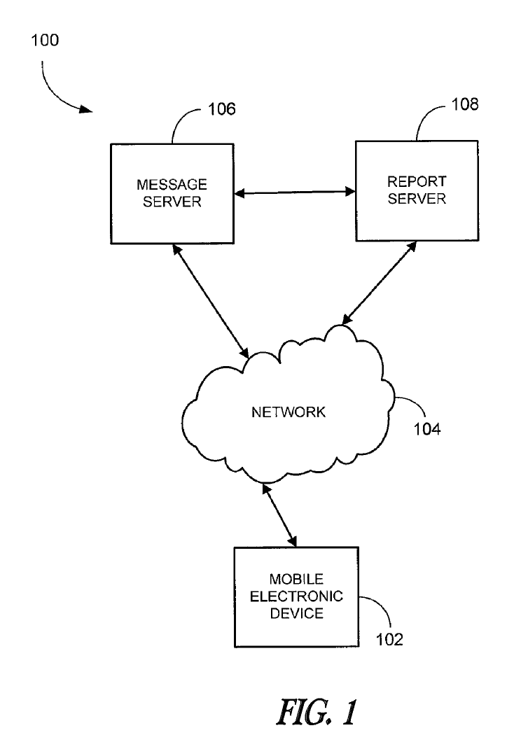

FIG. 1 illustrates an example system 100 comprising various entities or apparatuses. As shown, system 100 includes a mobile electronic device 102 that receives electronic messages from a message server 106 through a network 104. Typically, the received electronic messages include a number of electronic messages that are perceived by a user as being spam. In general, electronic messages that are unsolicited commercial messages or undesired bulk electronic messages are deemed spam. While it is very common for e-mail messages to be spam, other types of messages including short message service (SMS) messages, multimedia messaging service (MMS) messages, and instant messages (IMs) may also be spam.

When one or more received messages have been identified as spam by either a process on the mobile electronic device 102 or as indicated by the user of the mobile electronic device 102, a spam report is generated and transmitted through the network 104 to a recipient which may include the message server 106, a report server 108 or another entity. The server that receives and processes the spam report typically depends on a configuration of the system 100. The processing of the spam report is typically intended to improve the communication of future electronic messages by reducing spam.

The mobile electronic device 102 of the system 100 is a portable electronic device that enables its user to send and receive data, communicate with others through voice communications or otherwise, or both. The mobile electronic device 102 may include a communication portion (e.g., a transceiver apparatus or the like) configured to receive and transmit messages, and a processing portion (e.g., a microprocessor apparatus or the like) configured to process messages that are received by or that are intended to be transmitted by the communication portion.

The network 104 over which the mobile electronic device 102 is in communication with the message server 106, the report server 108, or both may include a Global System for Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

The mobile electronic device 102 is in communication with the message server 106 to send and receive electronic messages. For example, the message server 106 may be a server device (e.g., computing device configured with a communication portion, a processing portion and a message server application) that receives electronic messages for the user of the mobile electronic device 102 and transmits the electronic messages through the network 104 to the mobile electronic device 102. When the user of the mobile electronic device 102 seeks to send a particular electronic message to another user, the electronic message is transmitted through the network 104 to the message server 106 and further transmitted through the network 104 to another message server associated with the intended recipient or, alternatively, directly to the intended recipient if the intended recipient is known or otherwise determined to be associated with the message server 106.

In some instance the report server 108 receives and processes spam reports from the mobile electronic device 102. However, in other instances the report server 108 receives a spam report from the mobile electronic device 102 and forwards the spam report to another entity (e.g., a mobile operator server, an anti-spam vendor server and the like) for processing that may enable or otherwise facilitate blocking or minimizing additional spam based on the reference in the spam report. The report server 108 may operate separately from the message server 106, in conjunction with the message server 106, or be embodied as part of the message server 106. Furthermore, although the system of FIG. 1 is illustrated as including one message server 106 and one report server 108, the system 100 may be configured with additional servers 106, 108. The report server 108 may provide information regarding spam to the message server 106 or to another entity (e.g., a an application or service-specific server that is configured to provide application or service functionality to a client or user agent that is executing on the mobile electronic device 102) in communication with network 104 to enable the message server 106 to improve its messaging.

FIG. 2 illustrates an example mobile electronic device 102 that may be deployed in the system 100, or otherwise deployed in another system. The mobile electronic device 102 is shown to include a spam reporting subsystem 202 to transmit spam reports about the electronic messages received. In some instances, the spam reporting subsystem 202 may be configured in a server (e.g., an application server that provides functionality to an application or client executing on the mobile electronic device 102). The spam reports may not include an entirety of the entire electronic message that has been identified as spam, but may instead include a portion of the electronic message.

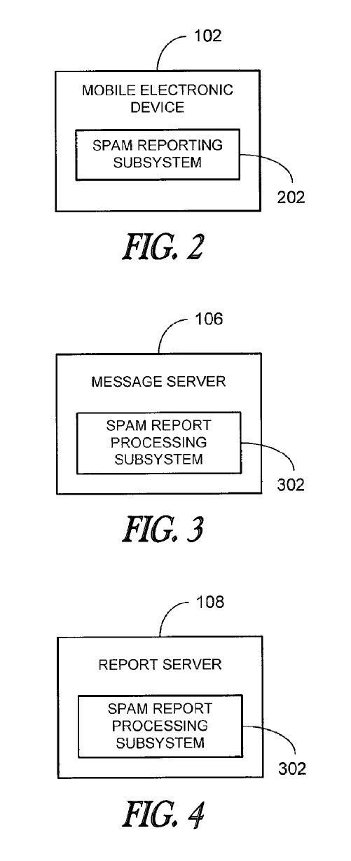

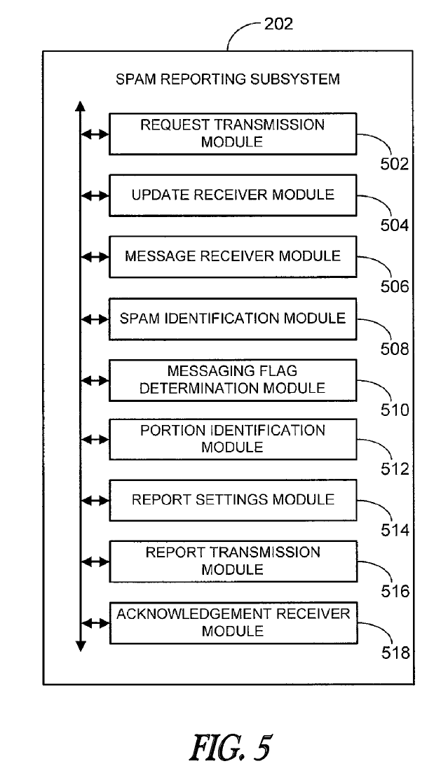

FIG. 3 illustrates an example message server 106 that may be deployed in the system 100, or otherwise deployed in another system. The message server 106 is shown to include a spam report processing subsystem 302 to process spam reports received from the mobile electronic device 102. The processing of the spam reports by the spam report processing subsystem 302 may enable the message server 106 to block, eliminate or minimize communication of additional electronic messages that the spam report processing subsystem 302 identifies as being spam. The spam reports may be otherwise used to improve messaging functionality.

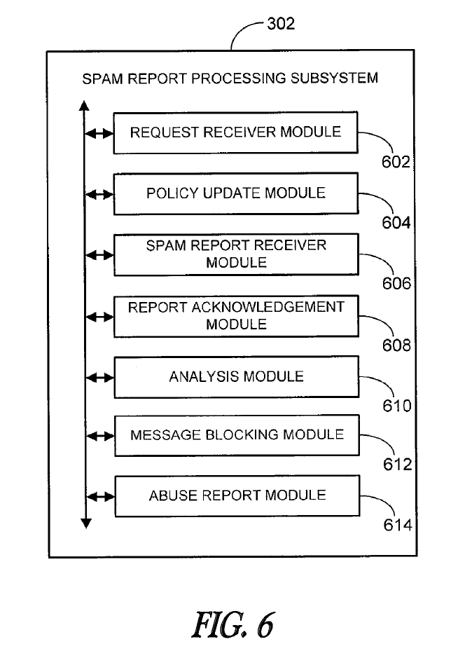

FIG. 4 illustrates an example report server 108 that may be deployed in the system 100, or otherwise deployed in another system. The report server 108 is shown to include the spam report processing subsystem 302 to process spam reports received from the mobile electronic device 102. In some instances, processing of the spam report by the report server 108 may comprise performing at least one of storing and forwarding of the spam report to another entity. The processing of the spam reports by the spam report processing subsystem 302 may enable the report server 108 to send out abuse reports or otherwise provide notification regarding spam with appropriate details.

In some embodiments, the spam report processing subsystem 302 is either deployed in the message server 106 or the report server 108. The spam report processing subsystem 302 is typically deployed in the message server 106 when the report server 108 is not used in the system 100. The message server 106 then includes much of the functionality of the report server 108, and is then responsible for both transmitting electronic messages to the mobile electronic device 102 and receiving spam reports from the mobile electronic device 102. The spam report processing subsystem 302 is typically deployed in the report server 108 when the message server 106 and the report server 108 are separately deployed in the system 100. In other embodiments, the spam report processing subsystem 302 may be configured in both of the message and report servers 106, 108 or distributed across the message and report servers 106, 108.

FIG. 5 illustrates an example spam reporting subsystem 202 that may be deployed in the mobile electronic device 102, or otherwise deployed in another system. One or more modules are included in the spam reporting subsystem 202 to enable spam reporting. The modules of the spam reporting subsystem 202 that may be included are a request transmission module 502, an update receiver module 504, a message receiver module 506, a spam identification module 508, a messaging flag determination module 510, a portion identification module 512, a report settings module 514, a report transmission module 516, and an acknowledgement receiver module 518. Other modules may also be included.

Prior to transmitting a further spam report, in some embodiments the request transmission module 502 transmits a request to a server (e.g., the message server 106, the report server 108, or both) for the update for the spam report policy or spam report settings. The spam report policy is a set of rules and operational instructions to manage spam reporting to one or more servers (e.g., the servers 106, 108, or both). In some embodiments, the spam report policy is defined by a particular server. In other embodiments, the spam report policy is defined by an administrator of one or more servers. The spam report policy or spam report settings may be the same for all content types of electronic messages or different for one or more of the types of electronic messages. The setting may be different based on the originator of the same content type.

The update for the spam report policy is received from the server by the policy receiver module 504. The update may be received in response to the request transmitted by the request transmission module 502, or the update may be received without having provided such a request. In one embodiment, the update is pulled from the server. In another embodiment, the update is pushed to the mobile electronic device 102.

A number of electronic messages for the mobile electronic device 102 are received by the message receiver module 506. The electronic messages received by the mobile electronic device 102 may be of one or more message types. In one embodiment, the electronic message is a SMS message. In another embodiment, the electronic message is a MMS message. In yet another embodiment, the electronic message is an e-mail message. In another embodiment, the electronic message is an IM.

While a number of the received messages are communications that are not spam (e.g., sent by someone from whom the recipient knows or would otherwise accept an electronic message), others are spam or may be perceived as being spam. Electronic messages that are spam are typically unsolicited commercial messages or undesired bulk electronic messages. One or more of the received messages may be automatically identified by the spam identification module 508 as being spam messages. The automatic identification may, in one embodiment, be based on spam filtering technology. The spam identification module 508 may also receive identification from the user of one or more electronic messages as being spam. The actual electronic messages that have been identified as spam may or may not actually be spam. However, the spam identification module 508 at least identifies or receives identification that the received message is spam.

In some embodiments, the messaging flag determination module 510 is deployed within the spam reporting subsystem 202 to determine whether a report messaging flag is set to a full content report setting or a partial content report setting. When the report messaging flag is set to the full content report setting, the spam reports include the copy of the entire electronic message that is identified as spam. When the report messaging flag is set to the partial content report setting, the spam report includes the portion of the electronic message without including the copy of the entire electronic message. When the messaging flag determination module 506 is not deployed within the spam reporting subsystem 202 or is not set, in some embodiments the spam report may either automatically include the portion of the electronic message without including the copy of the entire electronic message itself, or may include the copy of the entire electronic message. In other embodiments, the flag may be any type of indicator to identify whether or not to include the copy of the entire electronic message or the portion of the electronic message.

The portion identification module 512 uses the spam report policy on the mobile electronic device 102 to identify the portion of the electronic message to include with the spam report. The portion of the electronic message may include one or more of a header, a message body, an attachment, or multiple parts of the electronic message. The portion identification module 512 may use the spam report policy in one or more of the following ways.

In one embodiment, a message type of the electronic message is identified and the portion of the electronic message is selected for the spam report based on the spam report policy for the message type. The message type may include, by way of example, an email message, a SMS message, a MMS message, or an IM.

In another embodiment, a server type of the server that transmitted the electronic message to the mobile electronic device 102 is identified and the portion of the electronic message is selected for the spam report based on the spam report policy for the server type. In one embodiment, the server type includes a business mail server or a commercial mail server.

In yet another embodiment, a source of the server that transmitted the electronic message to the mobile electronic device 102 is identified and the portion of the electronic message for the spam report is selected based on the spam report policy for the server source. The sources are operated by different messaging server providers. For example, the electronic messages of a first source may include one or more particular portions of the electronic messages, while electronic messages of a second source may include one or more different portions of the electronic messages.

In another embodiment, a determination is made as to whether a content type defined within the electronic message is included on a whitelist, a blacklist or both, and the portion of the electronic message for the spam report is selected based on the spam report policy for the content type. The whitelist approves certain content types of the electronic message for inclusion with the portion, while the blacklist excludes certain content types from inclusion.

The content type may be defined in a header of the electronic message and indicate the media type of the message content, consisting of a type and subtype, for example. Examples for the content include text plus attachments), a reply with original attached, alternative content, such as an electronic message sent in both plain text and another format such as HTML, or image, audio, video and application. The content type may then be respectively defined as multipart/mixed with a text/plain part and other non-text parts, multipart/mixed with a text/plain part and the original message as a message/rfc822 part, multipart/alternative with the same content in text/plain and text/html forms and, for example, image/jpg, audio/mp3, video/mp4, and application/msword and the like.

In another embodiment, a determination of whether content of the content type defined within the electronic message is greater than a size threshold and the portion of the electronic message for the spam report is selected based on the spam report policy for a content type size threshold. For example, the portion of the electronic message that may be selected based on the spam report policy for the content type size threshold may include at least one other content type defined within the electronic message that is not greater than the size threshold. In one particular embodiment, the portion of the electronic message that may be selected based on the spam report policy for the content type size threshold may include partial content of the electronic message of the content type. For example, a partial portion of the text of the message body of the electronic message (e.g., the first 20K of 50K) may be selected as the portion.

In some embodiments, the report settings module 514 is included instead of the portion identification module 512 to use one or more spam report settings on the mobile electronic device to identify the portion of the electronic message to include with the spam report. The spam report settings may then be used to identify the portion of the electronic message as described above.

In other embodiments, the report settings module 514 uses one or more spam report settings on the mobile electronic device 102 to identify whether to include the copy of the entire electronic message with the spam report or the portion of the electronic message with the spam report without including the copy of the entire electronic message. In these embodiments, the report settings module 514 may be used in conjunction with the portion identification module 512.

The report transmission module 516 transmits the spam report from the mobile electronic device 102 to the server (e.g., the message server 106, the report server 108, or both). The spam report notifies the server that one or more electronic messages are spam and includes the portion of the electronic messages without including a copy of the entire electronic messages.

In some embodiments, a report acknowledgement is received by the acknowledgement receiver module 518 from the server. In one embodiment, the report acknowledgement includes an update for the spam report policy. In another embodiment, the report acknowledgement includes notification regarding availability of the update for the spam report policy.

FIG. 6 illustrates an example spam report processing subsystem 302 that may be deployed in at least one of the message server 106, the report server 108, or otherwise deployed in another system (e.g., an anti-spam infrastructure comprising an anti-spam vendor's server or the like). One or more modules are included in the spam report processing subsystem 302 to enable processing of the spam reports. The modules of the spam report processing subsystem 302 which may be included are a request receiver module 602, a policy update module 604, a spam report receiver module 606, a report acknowledgement module 608, an analysis module 610, a message blocking module 612, and an abuse report module 614. Other modules may also be included.

In some embodiments, the request receiver module 602 receives the request from the mobile electronic device 102 for the update for the spam report policy. The update for the spam report policy is transmitted to the mobile electronic device 102 by the policy update module 604. The update may be transmitted in response to the request, at regular times, in response to a certain action (e.g., the receipt of a previous spam report), or otherwise transmitted.

The spam report is received through the network 104 from the mobile electronic device 102 by the spam report receiver module 606. The spam report includes the notification that the electronic message is spam. The spam report further includes the portion of the electronic message without including the entire electronic message.

Once the spam report is received, the report acknowledgement may be is transmitted to the mobile electronic device 102 by the report acknowledgement module 608. In some embodiments, the report acknowledgement includes the update for the spam report policy. In other embodiments, the report acknowledgement includes notification regarding availability of the update.

The spam report is analyzed by the analysis module 610. The analysis may be performed to determine whether any action should be taken by the server.

In one embodiment where the spam report processing subsystem 302 is deployed in the message server 106, the message blocking module 612 may be included and additional electronic messages may be blocked based on the receipt of the spam report, analysis of the spam report, or both. In another embodiment where the spam report processing subsystem 302 is deployed in the report server 108, the abuse report module 614 may be included and transmit an abuse report to the message server 106 based on the ascertaining. The abuse report may be exchanged with other network operators and other parties. In one embodiment, the abuse report is a message/feedback-report.

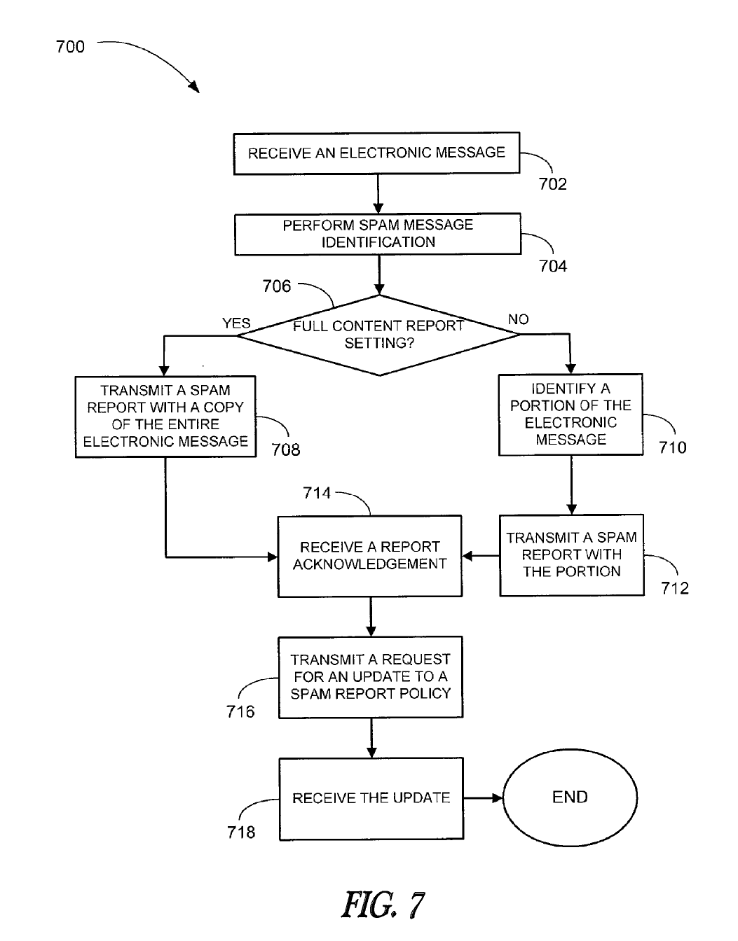

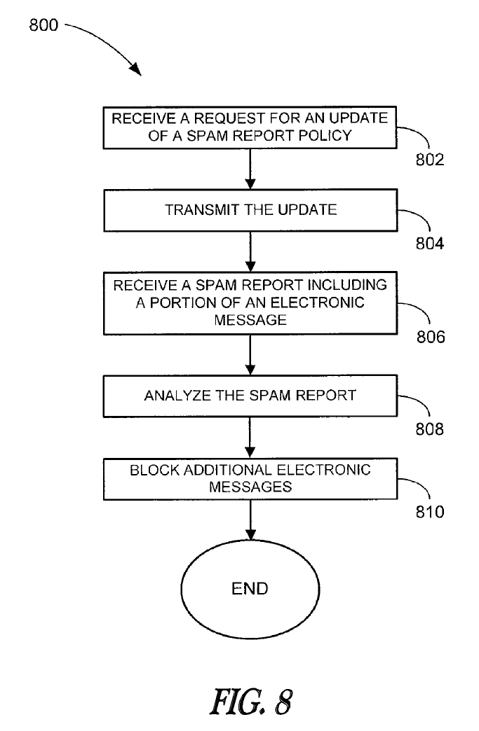

FIG. 7 illustrates a method 700 for spam reporting according to an example embodiment. The method 700 may be performed by the mobile electronic device 102 or one of the servers 106, 108 of the system 100 (see FIG. 1), or may be otherwise performed.

The electronic message is received on the mobile electronic device 102 at block 702. The electronic message is typically received from the message server 106 based on a preexisting relationship between the mobile electronic device 102 and the message server 106. For example, the message server 106 may be associated with an operator or a service provider of which the user is an authorized user.

In one embodiment, the received message is a SMS message. In another embodiment, the received message is a MMS message. In yet another embodiment, the received message is an e-mail message. In another embodiment, the received message is an IM.

The electronic message received by the mobile electronic device 102 may or may not be an actual a spam message. Spam message identification may therefore be performed at block 704 to identify the received message as spam. In one embodiment, the mobile electronic device 102 identifies the received message as being a spam message. The identification may be based on certain aspects of the message such as apparent sender address, routing information, type of content, or the like. In another embodiment, identification of the received message as a spam message is received from the user of the mobile electronic device 102. The user may make such a determination by reviewing the electronic message. The user may then inform the mobile electronic device 102 of the identification through a user interface.

Once the electronic message has been identified as being spam, the mobile electronic device 102 may seek to transmit the spam report that identifies one or more electronic messages as being spam. In some embodiments, the information included in the spam report is not always fixed. Rather, a determination is made to as to what information will be included. In one implementation, one or more spam report settings (e.g., as defined by a policy) are used on the mobile electronic device 102 to identify whether to include the copy of the entire electronic message with the spam report or the portion of the electronic message with the spam report without including the copy of the entire electronic message. In another implementation, the report messaging flag is used on the mobile electronic device 102 to make a determination. The report messaging flag is used, in one embodiment, to identify whether the spam report should include the entire electronic message or only the portion of the electronic message without a copy of the entire electronic message. The portion may include header information, a message body, or an attachment. When the portion is used instead of the copy of the entire electronic message, the size of the spam report is smaller. The report messaging flag or policy may be set by the message server 106, the report server 108, or may be otherwise set (e.g., by an operator, a service provider, etc.).

A determination of whether the report messaging flag is set to (or whether the policy specifies) the full content report setting or the partial content report setting may be made at decision block 706. If the full content report setting is identified, a spam report with the copy of the entire electronic message is transmitted to the server 108 at block 708. If, however, the partial content report setting is identified, the spam report policy (or one or more spam report settings) is used to identify the portion of the electronic message to include with the spam report. When the report messaging flag is not present, the portion of the electronic message may be automatically obtained at block 710.

The spam report policy (or one or more spam report settings) may be used to identify the portion for the spam report in one or more different ways.

In some embodiments, the message type of the electronic message is identified and the portion of the electronic message is selected for the spam report based on the spam report policy for the message type. The message type may include, by way of example, an email message, a SMS message, a MMS message, or an IM.

In some embodiments, the server type that transmitted the electronic message to the mobile electronic device 102 is identified and the portion of the electronic message is selected for the spam report based on the spam report policy for the server type. The server type may include a business mail server or a commercial mail server.

In some embodiments, the source of the server that transmitted the electronic message to the mobile electronic device 102 is identified and the portion of the electronic message is selected for the spam report based on the spam report policy for the source of the server.

In some embodiments, a determination of whether the content type defined within the electronic message is included on a whitelist, a blacklist, or both is made and the portion of the electronic message is selected for the spam report based on the spam report policy for the content type.

In some embodiments, a determination of whether content of a content type defined within the electronic message is greater than a size threshold is made and the portion of the electronic message is selected for the spam report based on the spam report policy for a content type size threshold. In some embodiments, the portion of the electronic message includes at least one other content type defined within the electronic message that is not greater than the size threshold. In other embodiments, the portion of the electronic message includes partial content of the electronic message of the content type.

Once the portion has been identified, the spam report is transmitted from the mobile electronic device 102 to the server at block 712. The spam report notifies the server that the electronic message is spam. The spam report includes the portion of the electronic message identified by use of the spam report policy without including the copy of the entire electronic message.

A report acknowledgement may be received from the server at block 714. In embodiment, the report acknowledgement includes the update for the spam report policy. In another embodiment, the report acknowledgement includes notification regarding availability of the update for the spam report policy. The update may include an updated version of the spam report policy, modifications to the spam report policy stored on the mobile electronic device 102, or both.

In some embodiments, the request for the update for the spam report policy is transmitted to the server at block 716. The update for the spam report policy may be received from the server and processed at block 718. The update may be received in response to the request, or may be transmitted by the report server without having received such a request.

In an example embodiment, the method 700 may reduce the size of spam reports sent between the mobile electronic device 102 and the server. The reduction may reduce the congestion on the network 104.

FIG. 8 illustrates a method 800 for spam report processing according to an example embodiment. The method 800 may be performed by the message server 106 of the system 100 (see FIG. 1), or may be otherwise performed. The method 800 may be performed when the system 100 does not include the report server 108 separately from the message server 106.

In some embodiments, the request from the mobile electronic device 102 for the update for the spam report policy is received at block 802. In response to the request, or without receiving the request, the update for the spam report policy may be transmitted to the mobile electronic device 102 at block 804.

The spam report is received at block 806 through the network 104 from the mobile electronic device 102. The received spam report includes a notification that the electronic message (or electronic messages) is spam and the portion of the electronic message without including the copy of the entire electronic message.

In some embodiments, the report acknowledgement is transmitted to the mobile electronic device 102 based on receipt of the spam report. The spam report may be analyzed at block 808.

In some embodiments, one or more additional electronic messages may be blocked based on receiving the spam report, the analysis performed on the spam report, or both at block 810. The blocking of the additional electronic messages may prevent, minimize or limit further spam being sent by a certain sender, or of being a certain message type, or the like.

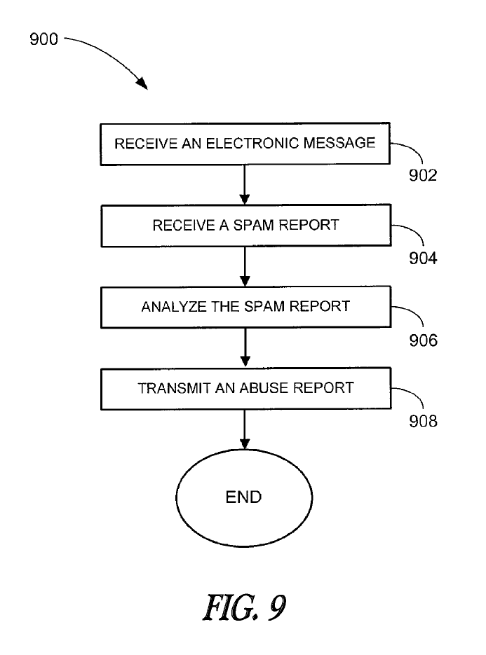

FIG. 9 illustrates a method 900 for spam report processing according to an example embodiment. The method 900 may be performed by the report server 108 of the system 100 (see FIG. 1), or may be otherwise performed. The method 900 may be performed when the system 100 includes both the message server 106 and the report server 108.

In some embodiments, a number of electronic messages are first received directly from the message server 106 at block 902. These electronic messages may be provided by the message server 106 substantially simultaneously with the transmission of the electronic messages to the mobile electronic device 102, or at a different time (e.g., at a delay, in a batch hourly, or the like) that is still in conjunction with the transmitting of the electronic messages to the mobile electronic device 102. The receipt of the electronic messages by the report server 108 may enable the report server 108 to process spam reports without further communicating with the message server 106.

The spam report is received at block 904 through the network 104 from the mobile electronic device 102. The received spam report includes the notification a particular electronic message (or more than one electronic messages) are spam. The spam report further includes the portion of the electronic message without including a copy of the entire electronic message.

Once the spam report is received, the spam report may be analyzed at block 906. The analysis may include investigating the source or the cause of the electronic message. In other embodiments, a person associated with the report server 108 may manually perform the analysis.

Depending on implementation and configuration of the report server 108, an abuse report based on the spam report, analysis, or both may be transmitted at block 908 to the message server 106, other message servers, or other report servers. In one particular embodiment, the abuse report is a message/feedback-report.

Certain systems, apparatus, applications or processes are described herein as including a number of modules. A module may be a unit of distinct functionality that may be presented in software, hardware, or combinations thereof. Functionality performed by one or more modules may be combined into a single module. Functionality performed by multiple modules may be performed by a single module. When the functionality of a module is performed in any part through software, the module includes a machine readable medium. The modules may be regarded as being communicatively coupled.

Methods and systems for spam reporting with a message portion have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

What is claimed is:

1. A method comprising:
receiving an electronic message on a mobile electronic device;
using a spam report policy on the mobile electronic device to identify a portion of the electronic message to include with a spam report, the electronic message being identified as spam by at least one of the device and a user of the device; and
transmitting the spam report from the mobile electronic device to a server, the spam report notifying the server that the electronic message is spam and including the portion of the electronic message without including a copy of the entire electronic message.

2. The method of claim 1, wherein the using comprises:
identifying a message type of the electronic message; and
selecting the portion of the electronic message for the spam report based on the spam report policy for the message type.

3. The method of claim 2, wherein the message type includes an email message, a short message service (SMS) message, a multimedia messaging service (MMS) message, or an instant message (IM).

4. The method of claim 1, wherein the using comprises:
identifying a server type that transmitted the electronic message to the mobile electronic device; and
selecting the portion of the electronic message for the spam report based on the spam report policy for the server type.

5. The method of claim 1, wherein the using comprises:
identifying a server source that transmitted the electronic message to the mobile electronic device; and
selecting the portion of the electronic message for the spam report based on the spam report policy for the server source.

6. The method of claim 1, wherein the using comprises:
determining whether content of a content type defined within the electronic message is greater than a size threshold; and
selecting the portion of the electronic message for the spam report based on the spam report policy for a the size threshold of the content type.

7. The method of claim 6, wherein the portion of the electronic message includes at least one other content type defined within the electronic message that is not greater than the size threshold.

8. The method of claim 6, wherein the portion of the electronic message includes partial content of the electronic message of the content type.

9. The method of claim 1, further comprising:
responsive to the transmitting, receiving a report acknowledgement from the server.

10. The method of claim 9, wherein the report acknowledgement includes an update for the spam report policy.

11. The method of claim 9, wherein the report acknowledgement includes notification regarding availability of an update for the spam report policy.

12. The method of claim 1, further comprising:
determining whether if the spam report policy defines a full content report setting or a partial content report setting;
wherein the spam report including the portion of the electronic message is transmitted when the spam report policy defines the partial content report setting.

13. The method of claim 1, wherein the spam report policy is a set of rules and operational instructions to manage spam reporting to the server.

14. The method of claim 1, wherein the portion includes a message body, an attachment, header information, or combinations thereof.

15. An apparatus comprising:
a communication portion configured to receive an electronic message; and
a processing portion configured to use a spam report policy for identifying a portion of the electronic message to include with a spam report, the processing portion being further configured, in cooperation with the communication portion, to transmit the spam report to a server, the spam report notifying the server that the electronic message is spam and including the portion of the electronic message specified by the spam report policy without including an entire copy of the electronic message.

16. The apparatus of claim 15, wherein the communication portion and the processing portion are configured in a mobile electronic device.

17. The device of claim 15, wherein the communication portion and the processing portion are configured in a server device.

18. The device of claim 17, wherein the server device is configured as an application or service provider server.

19. A server device comprising:
a communication portion configured to receive a spam report from a mobile electronic device, the spam report including a notification that an electronic message received by the mobile electronic device is spam and a portion of the electronic message without including an entirety of the electronic message; and
a processing portion configured, in cooperation with the communication portion, to transmit the spam report for facilitating blocking of additional electronic messages based on the portion.
